(19) United States
(12) Patent Application Publication
(10) Pub. No.: US 2026/0270673 A1
(43) Pub. Date: Sep. 10, 2026

(54) METHOD FOR TRANSMITTING AND RECEIVING SIGNAL IN WIRELESS COMMUNICATION SYSTEM, AND APPARATUS SUPPORTING SAME

(71) Applicant: LG ELECTRONICS INC., Seoul (KR)

(72) Inventors: Minsung KWAK, Seoul (KR); Hanbyul SEO, Seoul (KR); Yoonjong LEE, Seoul (KR); Jaihyun BYUN, Seoul (KR)

(73) Assignee: LG ELECTRONICS INC., Seoul (KR)

(21) Appl. No.: 19/480,009

(22) PCT Filed: Jun. 20, 2024
(86) PCT No.: PCT/KR2024/008509

§ 371 Date: Oct. 29, 2025

(30) Foreign Application Priority Data
Jun. 20, 2023 (KR) 10-2023-0078802

(51) Int. Cl. H04W 4/90; H04W 4/38; H04W 64/00

(52) U.S. Cl. CPC H04W 4/90; H04W 4/38; H04W 64/006

(57) ABSTRACT

A method by which an apparatus transmits a message in a wireless communication system, according to at least one of various embodiments, comprises: acquiring information regarding a vehicle through at least one sensor; on the basis of the acquired information regarding the vehicle, determining whether or not at least one of predefined basic safety message (BSM) transmission conditions is satisfied; and on the basis that at least one of the BSM transmission conditions is satisfied, transmitting a BSM including information regarding the location, speed, and direction of the vehicle, wherein, on the basis that the vehicle is a school bus, the BSM transmission conditions include: i) loading onto the school bus; ii) unloading from the school bus; and iii) crossing in front of or behind the school bus, and the BSM may include information regarding at least one condition satisfied from among the BSM transmission conditions.

### TECHNICAL FIELD

The present disclosure relates to a wireless communication system, and more specifically, to a method for transmitting and receiving a signal including information on vehicle safety in an intelligent transport system (ITS) and a device for performing the same.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

An intelligent transport system (ITS) is a form in which wireless communication technology is applied to achieve more efficient management of transportation systems and enhanced safety. The ITS may monitor traffic conditions in real time and collect and process data through closed-circuit television (CCTV), sensor networks, global positioning system (GPS) devices, and wireless communication systems. The ITS may support communication between vehicles. For example, vehicles may communicate with each other and share information on surrounding environments for autonomous driving and improved traffic safety.

### DISCLOSURE

### Technical Problem

The technical object is to transmit and receive safety messages for school buses in a wireless communication system.

The technical objects are not limited thereto, and additional technical objects not mentioned above can be derived from the disclosure.

### Technical Solution

In an aspect of the present disclosure, provided herein is a method of transmitting a message by a device in a wireless communication system. The method includes: acquiring information regarding a vehicle through at least one sensor; determining, based on the acquired information regarding the vehicle, whether at least one of predefined basic safety message (BSM) transmission conditions is satisfied; and based on that the at least one of the BSM transmission conditions is satisfied, transmitting a BSM including information regarding a location, a speed, and a heading of the vehicle. Based on that the vehicle is a school bus, the BSM transmission conditions may include: i) loading to the school bus; ii) unloading from the school bus; and iii) crossing in front of or behind the school bus. The BSM may include information regarding the at least one satisfied condition among the BSM transmission conditions.

In another aspect of the present disclosure, provided herein is a computer-readable recording medium having recorded thereon a program for executing the above-described method.

In another aspect of the present disclosure, provided herein is a device in a wireless communication system. The device includes: a memory configured to store instructions; and a processor configured to perform operations by executing the instructions. The operations performed by the processor include: acquiring information regarding a vehicle through at least one sensor; determining, based on the acquired information regarding the vehicle, whether at least one of predefined BSM transmission conditions is satisfied; and based on that the at least one of the BSM transmission conditions is satisfied, transmitting a BSM including information regarding a location, a speed, and a heading of the vehicle. Based on that the vehicle is a school bus, the BSM transmission conditions may include: i) loading to the school bus; ii) unloading from the school bus; and iii) crossing in front of or behind the school bus. The BSM may include information regarding the at least one satisfied condition among the BSM transmission conditions.

Whether the BSM transmission conditions are satisfied may be determined based on information acquired through a sensor of the school bus or a sensor of a road side unit (RSU).

Based on that at least two or more of the BSM transmission conditions are satisfied, the BSM may include information regarding each of the at least two or more satisfied conditions.

The BSM may be transmitted to at least one other vehicle around the school bus. The at least one other vehicle may stop based on the transmission of the BSM.

Based on that the BSM is related to at least one of: i) the loading to the school bus; ii) the unloading from the school bus; or iii) crossing in front of or behind the school bus, proximity services (ProSe) per-packet priority (PPPP) of the BSM may be determined.

The BSM transmission conditions may further include a case where a passenger of the school bus drops an object.

The device may be a device provided in the school bus or an RSU around the school bus

In another aspect of the present disclosure, provided herein is a method of receiving a message by a device in a wireless communication system. The method includes: receiving a BSM from a vehicle; and acquiring information regarding a location, a speed, and a heading of the vehicle from the BSM. The vehicle may be a school bus. The BSM may include information regarding at least one of: i) loading to the school bus; ii) unloading from the school bus; or iii) crossing in front of or behind the school bus.

In a further aspect of the present disclosure, provided herein is a device in a wireless communication system. The device includes: a memory configured to store instructions; and a processor configured to perform operations by executing the instructions. The operations performed by the processor include: receiving a BSM from a vehicle; and acquiring information regarding a location, a speed, and a heading of the vehicle from the BSM. The vehicle may be a school bus. The BSM may include information regarding at least one of: i) loading to the school bus; ii) unloading from the school bus; or iii) crossing in front of or behind the school bus.

Based on that at least two or more of BSM transmission conditions are satisfied, the BSM may include information regarding each of the at least two or more satisfied conditions.

The device may be a vehicle around the school bus. The device may stop based on the reception of the BSM.

The device may be a device provided in the school bus or an RSU around the school bus.

### Advantageous Effects

According to an embodiment of the present disclosure, the safety of a school bus and passengers may be improved through transmission and reception of a basic safety message (BSM) in a wireless communication system.

The effects that can be obtained in various embodiments are not limited to the effects mentioned above, and other effects not mentioned can be derived from the description below.

### BRIEF DESCRIPTION OF THE DRAWINGS

FIG. 1 is a diagram for explaining vehicle-to-everything (V2X) communication.

FIG. 2 illustrates a radio protocol architecture for sidelink (SL) communication.

FIG. 3 illustrates UEs performing V2X or SL communication.

FIG. 4 illustrates a blind spot in which the field of view of a bus driver is limited.

FIG. 5 illustrates a danger zone around a bus.

FIG. 6 illustrates an example of basic safety message (BSM) message transmission including school bus-related information by a school bus or a road side unit (RSU).

FIG. 7 is a diagram for explaining BSM transmission by a school bus according to an embodiment.

FIG. 8 is a diagram for explaining message transmission by an RSU according to an embodiment.

FIG. 9 illustrates a flow of a method of transmitting a BSM according to an embodiment.

FIG. 10 illustrates a flow of a method of receiving a BSM according to an embodiment.

FIG. 11 illustrates a communication system applied to the present disclosure.

FIG. 12 illustrates wireless devices applicable to the present disclosure.

FIG. 13 illustrates another example of a wireless device to which the present disclosure is applied.

FIG. 14 illustrates a vehicle or an autonomous driving vehicle applied to the present disclosure.

### DETAILED DESCRIPTION

A sidelink (SL) refers to a communication method in which a direct link is established between user equipment (UE), and voice or data is directly exchanged between UEs without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

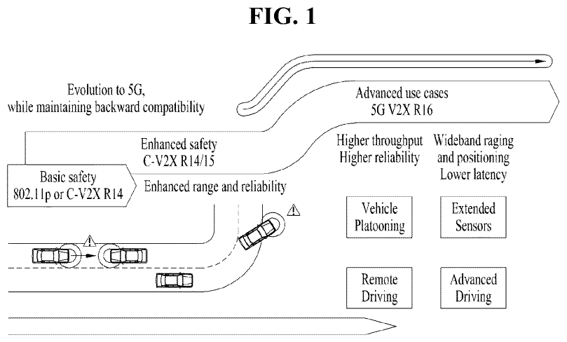

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

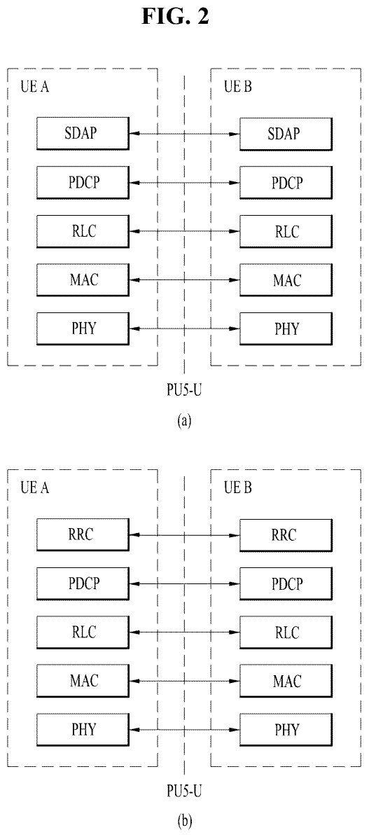

FIG. 2 illustrates a radio protocol architecture for SL communication. Specifically, FIG. 2-(a) shows a user plane protocol stack of NR, and FIG. 2-(b) shows a control plane protocol stack of NR.

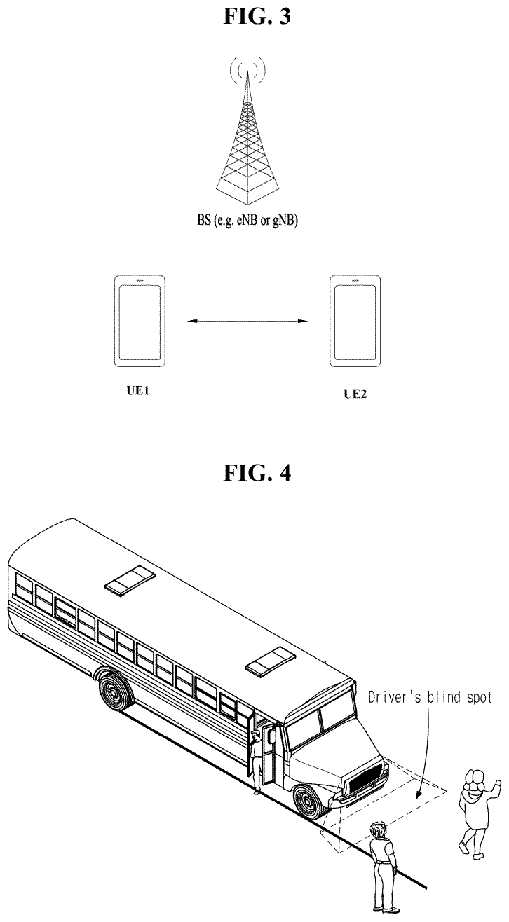

FIG. 3 illustrates UEs performing V2X or SL communication.

Referring to FIG. 3, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

Transmission and Reception of Messages Associated with School Bus Safety

To ensure the safety of students, standardization for V2X safety applications of school buses is in progress, and a method of sharing state information of the school bus is under discussion.

A school bus equipped with a V2X safety application may transmit the state information thereof through messages such as a BSM. To this end, the BSM may be configured by defining a new school bus type in a vehicle type field of the BSM and by modifying and extending a special vehicle extension field used in the BSM to include the state information of the school bus.

The state information related to the school bus to be included in the BSM may include the contents shown in Table 1. However, the state information is not limited thereto.

TABLE 1
Slowing down - indicating potential for the bus to stop to load or unload
children
- Assess need to take into account local traffic)
Yellow flashing lights - indicates the bus is preparing to stop to load or
unload children
Red flashing lights - indicates the bus has stopped and children are getting
on or off.
Extended stop arms - indicates the bus has stopped and children are
getting on or off.
Door Open/Door Close - possible indicator of children getting on or off
- At Bus Stop (designated pick up and drop off zones)
- In a school zone
Some entities may want to get the following alerts:
Exceeding speed limits
Hard braking and acceleration
Deviation from approved bus routes (Require access to backend data)
Battery level alerts for Electric School Buses

Meanwhile, if an on-board unit (OBU) or the V2X safety application mounted on the school bus fails to automatically detect the corresponding information, the school bus driver may have to manually input the related information into the V2X safety application to configure the BSM. In such a case, the reliability of the corresponding information may be reduced.

To solve such a problem, the present disclosure proposes a method for configuring and transmitting a BSM for a school bus. According to the proposed method, when a school bus transmits state information by including the state information in a BSM using a V2X safety application therein, even if an OBU or the V2X safety application mounted on the school bus is capable of automatically sensing and detecting the information, the school bus may provide more efficient and reliable state information by using a device mounted on the school bus. In addition, more reliable information may be provided as a BSM by employing an additional device capable of providing information that the OBU or the V2X safety application is incapable of automatically sensing and detecting.

### BSM Transmission Based on Sensors Provided in School Bus

For example, a method is proposed in which a school bus is equipped with onboard sensors, and information recognized by the sensors at a designated boarding and alighting stop is included in a BSM.

A sensor capable of sensing the interior and exterior of a bus to detect passengers (including adults, students, and children) boarding or alighting from the bus and to acquire corresponding information may be provided in the school bus. If such a sensor is used, detailed information of passengers boarding or alighting from the school bus (e.g., the number of passengers boarding or alighting, state, distribution area, and movement direction) may be detected.

When passengers alight at a school bus stop, school bus information related to the period as the bus approaches the designated alighting stop, safely stops at the alighting stop, and passengers alight may be transmitted.

Table 2 shows an example of information related to passenger alighting, which may be transmitted as a BSM.

TABLE 2
SchoolbusPassengerGetOffInfo ::= SEQUENCE {
GetOffStatus ::= Approaching/PassengerReady/GettingOff
NumPassengerToGetOff ::= INTEGER
BoundingBoxOfPassengerGettingOff ::= BoundingBox of Passenger
cluster
TimeRequiredToStop ::= Time
BusStopPosition ::= Position3D
BusStopID ::= BusStopID
PassengerCrossing ::= Crossing/Not crossing
NumPassengerCrossing ::= INTEGER
BoundingBoxOfPassengerCrossing ::= BoundingBox of Passenger cluster
. . .
}

Each field in Table 2 is defined as follows.
(i) GetOffStatus: GetOffStatus indicates information on the operation of passengers alighting from the school bus. When the school bus has not yet arrived at the bus stop but enters a designated range (e.g., within a radius of 20 meters from the designated bus stop) and moves while reducing the speed to stop, the corresponding value is set to “Approaching.” After the school bus completes stopping at the designated alighting stop, while the passengers to alight rise from the seats and approach the door, the value is set to “PassengerReady.” When the preparation of the passengers to alight is completed and the door of the bus is opened and alighting begins, the value is set to “GettingOff.”
(ii) NumPassengerToGetOff: NumPassengerToGetOff indicates the number of passengers to alight from the bus, which is detected by an internal sensor of the bus when GetOffStatus is in the “PassengerReady” state.
(iii) BoundingBoxOfPassengerGettingOff: The distribution area of passengers who are alighting may be represented in a form such as a bounding box, for example, a vulnerable road user (VRU) cluster. The distribution area of school bus passengers during alighting may be expressed in the following three methods, but the present disclosure is not limited thereto.
   Circle (the centre of a circle, radius)
   Rectangle (the reference point, length, width)
   Polygon (list of positions which indicate polygon points)
(iv) TimeRequiredToStop: TimeRequiredToStop is based on the number of passengers who will alight or are alighting from the school bus. Specifically, TimeRequiredToStop refers the expected time during which the school bus remains stopped at the designated alighting stop by considering the time until passengers finish crossing the road after alighting. Additionally, the scheduled arrival time at a next designated bus stop may also be considered.
(v) BusStopPosition: BusStopPosition refers to the location at which the school bus will stop. If the bust temporarily stops at a location other than the designated stop, related information may be included and transmitted.
(vi) BusStopID: When the school bus stops at the designated stop, the bus stop ID of the designated stop may be included in the information message of the passengers alighting from the school bus.
(vii) PassengerCrossing: Referring to FIG. 4, the school bus has a blind spot of the driver in which the field of view of the driver is limited. For such a blind spot, it is possible to determine whether there are passengers crossing in front of the bus, through sensors mounted on the bus. In addition, after the school bus stops, it is possible to determine whether there are passengers who cross the road through the front or rear of the school bus among the alighted passengers. Such information may be included in the passenger alighting state information message of the school bus.
(viii) NumPassengerCrossing: The number of passengers crossing the road after alighting from the bus may be detected through sensors mounted on the school bus, and such information may be included in the message.
(ix) BoundingBoxOfPassengerCrossing: The distribution area of passengers crossing the road after alighting from the bus may be represented in a form such as a bounding box, for example, a VRU cluster. The distribution area of school bus passengers crossing the road may be expressed in the following three methods, but the present disclosure is not limited thereto.
   Circle (the centre of a circle, radius)
   Rectangle (the reference point, length, width)
   Polygon (list of positions which indicate polygon points)

In addition to or separately from the information related to passenger alighting described above, information related to passenger boarding may also be provided as a BSM.

When passengers waiting at a school bus boarding stop board a school bus, school bus information related to the period as the bus approaches the designated boarding stop, safely stops at the boarding stop while the waiting passengers board, and until the bus departs after the boarding is completed may be transmitted.

Table 3 shows an example of information related to passenger boarding, which may be transmitted as a BSM.

TABLE 3
SchoolbusPassengerRideInfo ::= SEQUENCE {
RideStatus ::= Approaching/ReadyToRide/Riding and Sitting
NumPassengerToRide ::= INTEGER
BoundingBoxOfPassengerToRide ::= BoundingBox of Passenger cluster
TimeRequiredToMove ::= Time
BusStopPosition ::= Position3D
BusStopID ::= BusStopID
PassengerCrossing ::= Crossing/Not crossing
NumPassengerCrossing ::= INTEGER
BoundingBoxOfPassengerCrossing ::= BoundingBox of Passenger cluster
. . .
}

Each field in Table 3 is defined as follows.
(i) RideStatus: RideStatus indicates state information on the operation of passengers who intend to board the school bus. When the school bus has not yet arrived at the boarding stop but enters a designated range (e.g., within a radius of 20 meters from the designated boarding stop) and slows down while moving to stop for the waiting passengers, the corresponding value is set to “Approaching.” After the school bus confirms that the passengers waiting in line at the boarding stop are not in danger and completes stopping at the designated boarding stop until the boarding door of the bus is opened, the value is set to “ReadyToRide.” When the passengers waiting in line at the boarding stop begin to board through the opened door, the value is set to “RidingAndSitting.” Until it is confirmed through a sensor capable of sensing the interior of the bus that all passengers who were in line at the boarding stop have boarded and taken seats, the value may remain “RidingAndSitting.”
(ii) NumPassengerToRide: NumPassengerToRide indicates the number of passengers who are boarding or have boarded the bus, which is detected through a sensor capable of sensing the interior or exterior of the bus.
(iii) BoundingBoxOfPassengerToRide: The distribution area of passengers waiting at the boarding stop or boarding the school bus may be represented in a form such as a bounding box, for example, a VRU cluster. The distribution area of school bus passengers may be expressed in the following three methods, but the present disclosure is not limited thereto.
   Circle (the centre of a circle, radius)
   Rectangle (the reference point, length, width)
   Polygon (list of positions which indicate polygon points)
(iv) TimeRequiredToMove: TimeRequiredToMove is based on the number of passengers who are to board or have boarded and taken seats. Specifically, TimeRequiredToMove refers to the expected time during which the school bus remains stopped at the boarding stop before departing to a next boarding stop by confirming that the passengers are safely seated after boarding. Additionally, the scheduled arrival time at the next designated boarding stop and the waiting time for a delayed passenger who reserved boarding at the stop but has not boarded may also be considered.
(v) BusStopPosition: BusStopPosition refers to the location at which the school bus stops for boarding. If the bus temporarily stops at a location other than the designated boarding stop, related information may be included and transmitted.
(vi) BusStopID: When the school bus stops at the designated boarding stop, the bus stop ID of the designated stop may be included in the information message of the passengers boarding the school bus.
(vii) PassengerCrossing: A blind spot of the school bus driver may be monitored through sensors mounted on the bus, thereby determining whether there are passengers crossing in front of the bus.
(viii) NumPassengerCrossing: The number of passengers crossing the road to board the bus may be detected through sensors mounted on the school bus.
(ix) BoundingBoxOfPassengerCrossing: The distribution area of passengers crossing the road to board the bus may be represented in a form such as a bounding box, for example, a VRU cluster. The distribution area of school bus passengers crossing the road may be expressed in the following three methods, but the present disclosure is not limited thereto.
   Circle (the centre of a circle, radius)
   Rectangle (the reference point, length, width)
   Polygon (list of positions which indicate polygon points)

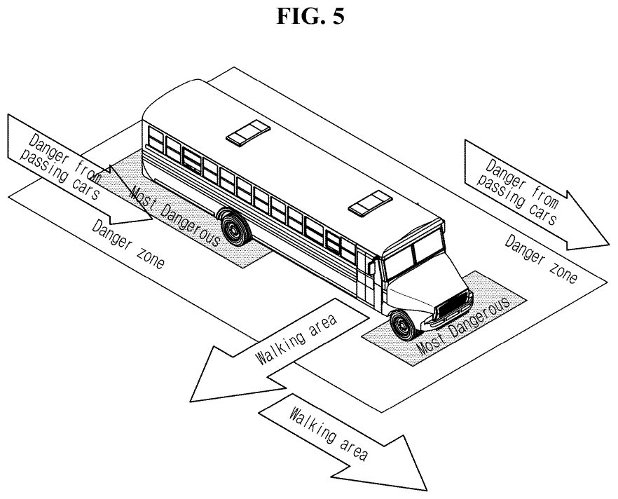

Meanwhile, as illustrated in FIG. 5, a danger zone exists around the stopped school bus. The danger zone may include an area in which there is a risk of collision between another vehicle and passengers boarding or alighting, and/or a blind spot of the driver. Thus, the present disclose proposes a method of providing information on situations occurring in such a danger zone as a BSM.

For example, when an object is dropped in the school bus danger zone while the school bus is stopped for boarding or alighting, such a situation may be detected through onboard sensors mounted on the school bus. Even if a child does not inform the bus driver of the situation, a warning or notification may be provided such that the driver inside the bus or a school bus assistant is aware of the situation.

In addition, in this case, since the school bus driver should keep the bus stopped while retrieving the item of the child outside the bus, the situation may be notified to approaching vehicles. A message including information on the stop of the school bus may be directly transmitted from the school bus to other vehicles, or the information may be transmitted from an RSU located near the bus stop to surrounding vehicles to notify the vicinity.

For example, information on the cause of the school bus stop may be transmitted as a BSM as shown in Table 4.

TABLE 4

SchoolbusStopReason ::= ENUMERATED {
Unavailable (0),
GetOff (1),
Ride (2),
DropAndPick (3),
Waiting (4),
. . .
}

Each field in Table 4 is defined as follows.
(i) Unavailable: Unavailable refers to a case where it is difficult to identify the reason why the bus is stopped, and thus the information may not be accurately specified.
(ii) GetOff: GetOff refers to a case where the bus stops for passengers on board the school bus to alight.
(iii) Ride: Ride refers to a case where the bus stops for passengers to board the school bus
(iv) DropAndPick: DropAndPick refers to a case where the bus stops because an object is dropped around the school bus and the driver stops the bus to retrieve the dropped object.
(v) Waiting: Waiting refers to a case where the bus stops in order to operate according to a designated timetable of the school bus or to wait for a passenger who is scheduled to board but has not yet arrived.

Alternatively, VehicleEventFlag is defined in the standard in order for a vehicle or an RSU to notify surrounding vehicles of event information. Items related to the school bus may be added to VehicleEventFlag.

Referring to Table 5, eventSchoolbusDropAndPick is added to VehicleEventFlag. Here, eventSchoolbusDropAndPick may indicate a case where the school bus stops because an object is dropped around the school bus and the driver stops the bus to retrieve the dropped object.

TABLE 5
VehicleEventFlags ::= BIT STRING {
eventHazardLights (0),
eventStopLine Violation (1), -- Intersection Violation
eventABSactivated (2),
eventTractionControlLoss (3),
eventStabilityControlactivated (4),
eventHazardousMaterials (5),
eventReserved1 (6),
eventHardBraking (7),
eventLightsChanged (8),
eventWipersChanged (9),
eventFlatTire (10),
eventDisabledVehicle (11), -- The DisabledVehicle DF may also be sent
eventAirBagDeployment (12),
eventJackKnife (13) -- Applies to vehicles with trailer(s)
eventSchoolbusDropAndPick (14)
} (SIZE (15, . . .))

For example, state information of school bus passengers (SchoolbusPassengerStatus) recognizable by onboard sensors mounted on the school bus may be configured as shown in Table 6 and transmitted as a BSM.

TABLE 6

SchoolbusPassengerStatus ::= SEQUENCE {
GetOff SchoolbusPassengerGetOffInfo
Ride SchoolbusPassengerRideInfo
DropAndPick SchoolbusDropSthEventInfo
Waiting SchoolbusWaitingInfo
. . .
}

In Table 6, SchoolbusPassengerGetOffInfo may be the information defined above in Table 2, and SchoolbusPassengerRideInfo may be the information defined above in Table 3.

For example, referring to Table 7, the school bus information (SchoolbusInfo) transmitted as includes a BSM SchoolbusPassengerStatus. In Table 7, SchoolbusPassengerStatus classifies the state of school bus passengers more simply into boarding and alighting, compared to Table 6.

TABLE 7

SchoolbusInfo ::= SEQUENCE {
PassengerStatus SchoolbusPassengerStatus
PassengerLocation SchoolbusPassengerBoundingBox
CrossingPassengerInfo CrossingPassengerStatus
. . .
}
SchoolbusPassengerStatus ::= ENUMERATED {
Unavailable (0),
Ride (1),
GetOff (2),
}
SchoolbusPassengerBoundingBox ::= CHOICE {
Circle
Rectangle
Polygon
}
CrossingPassengerStatus ::= SEQUENCE {
CrossingToRide ::= Number, BoundingBox
CrossingAfterGetOff ::= Number, BoundingBox
}

In Table 7, SchoolbusPassengerBoundingBox may be distribution area information of passengers boarding or alighting, which is recognized by onboard sensors.
CrossingPassengerStatus may be information on passengers who are crossing the road either to board the school bus or after alighting, which is recognized by onboard sensors.
CrossingToRide includes information on the number of passengers crossing the road to board the school bus and the distribution area of passengers.
CrossingAfterGetOff includes information on the number of passengers crossing the road after alighting from the school bus and the distribution area of passengers. Message transmission by RSU

In addition to or separately from the above proposal, a method is proposed in which an RSU installed at a designated boarding and alighting stop of a school bus transmits school bus-related information by including the information in a message.

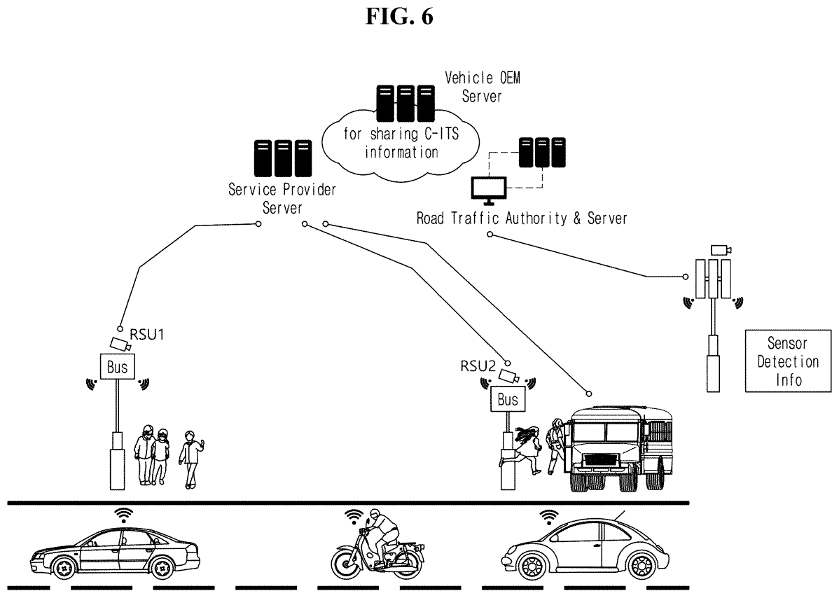

FIG. 6 illustrates an example of message transmission including school bus-related information by a school bus or an RSU.

The school bus may stop at a designated boarding stop on a designated route at a designated time to allow passengers to board. Referring to FIG. 6, RSU 1 and RSU 2 equipped with sensors are located at the designated school bus boarding stop. RSU 1 and RSU 2 sense passengers (children or parents) waiting for the school bus and configure related information into a message, transmits the message to approaching vehicles and motorcycles near the school bus boarding and alighting stop, and notify that there are passengers waiting to board the school bus at the boarding and alighting stop, thereby ensuring the safety of the passengers at the school bus boarding and alighting stop. In addition, RSU 1 and RSU 2 may transmit the information to a service provider server equipped with a school bus management system. Accordingly, the school bus connected to the server may be informed of the state of passengers waiting to board the bus at the designated boarding stop on the designated route. Table 8 shows an example of school bus-related information transmitted by an RSU.

TABLE 8

SchoolbusRelatedInfo ::= SEQUENCE {
BusStopPosition ::= Position3D
BusStopID ::= BusStopID
NumPeople Waiting ::= INTEGER
BoundingBoxOfPeopleWaiting ::= Bounding box of people
. . .
}

In Table 8, BusStopPosition may provide three-dimensional information on the stopping position of the bus. BusStopID is identification information of the boarding and alighting stop. NumPeopleWaiting refers to the number of passengers detected at the boarding and alighting stop. BoundingBoxOfPeopleWaiting may be information on the distribution area of passengers detected at the boarding and alighting stop.

For example, in addition to or separately from message transmission by the RSU, the school bus may transmit school bus operation information shown in Table 9 to a service provider server including a school bus management system after stopping at the boarding or alighting stop.

TABLE 9

SchoolbusBoardingInfo ::= SEQUENCE {
CurrentBusStopPosition ::= Position3D
BusStopID ::= BusStopID
NumPassengerOnBoard ::= INTEGER
NextBusStopPosition ::= BusStopID
NextBusStopExpectedArrivalTime ::= Time
BusNumber ::= BusID
. . .
}

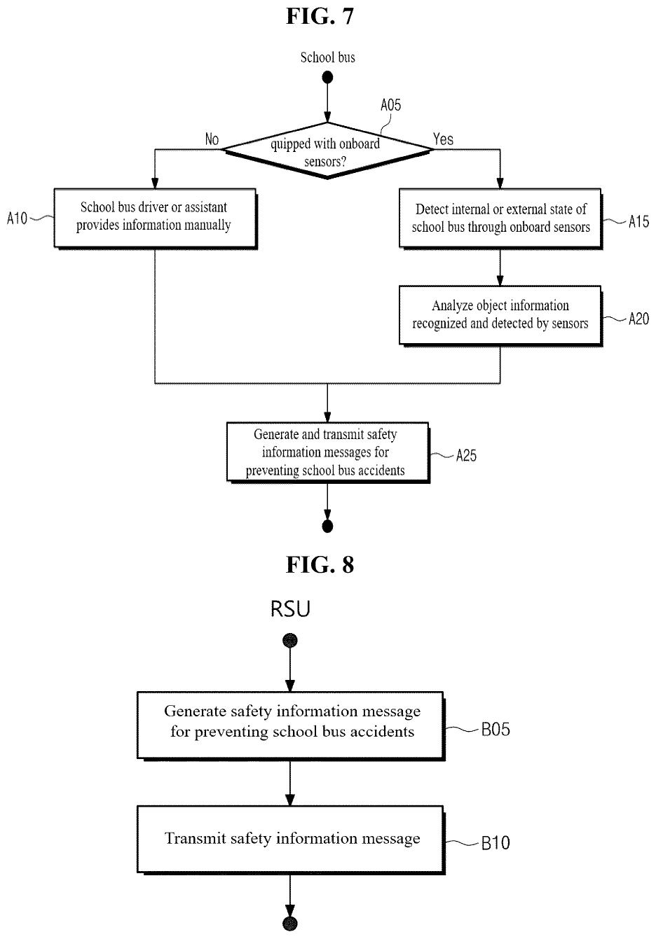

In Table 9, CurrentBusStopPosition may provide three-dimensional information on the current position of the bus. BusStopID is identification information of the boarding and alighting stop. NumPassengerOnBoard refers to the number of passengers who have boarded the bus. NextBusStopPosition is identification information of the next boarding and alighting stop at which the bus will stop. NextBusStopExpectedArrivalTime is information on the time at which the bus is expected to arrive at the next boarding and alighting stop. BusNumber is identification information of the bus. For example, the movement location of the vehicle and the expected arrival time at a specific boarding or alighting stop may be provided by linking the vehicle number of the school bus. FIG. 7 is a diagram for explaining BSM transmission by a school bus according to an embodiment.

Referring to FIG. 7, when a school bus is not equipped with onboard sensors, a school bus driver or a crew member may manually input school bus safety information (A10), and a BSM may be generated and transmitted (A25).

When the school bus is equipped with onboard sensors, the school bus may sense the internal or external state of the school bus through the sensors (A15).

The school bus analyzes object information recognized or detected through the sensing (A20).

Based on the analysis of the object information, the school bus may generate and transmit a BSM for school bus safety (A25).

FIG. 8 is a diagram for explaining message transmission by an RSU according to an embodiment.

The RSU acquires information on a school bus at a boarding and alighting stop through sensors and generates a message for school bus safety based on the information (B05).

The RSU may transmit the generated message to a service provider server including a school bus management system (B10).

Meanwhile, in the above description, it is assumed that a school bus (or RSU) transmits information on the school bus acquired through sensors as a BSM.

According to the existing standard, a BSM is not intended to transmit information acquired through sensors, but rather serves as a message for transmitting dynamic information of a vehicle, such as heading, speed, or position. The BSM may be periodically updated and broadcast to surrounding vehicles. An SDSM is a message defined for transmitting information acquired through sensors.

In the present disclosure, it is proposed that information acquired through sensors for a school bus is transmitted not as an SDSM but as a BSM. One reason therefor is that a BSM has a higher transmission priority than an SDSM, and therefore, a method of including school bus information in the BSM is proposed to transmit the information with higher priority and higher importance.

Specifically, traffic classification related to priority defined in the Society of Automotive Engineers (SAE) standard is shown in Table 10 below.

TABLE 10

| Traffic | Safety Services | | | | Mobility Services | | |
|---|---|---|---|---|---|---|---|
| Type | | | | | | | |
| Traffic | Critical | Essential | Critical | Essential | Transactional | Low | Background |
| Families | V2V | V2V | V2I-I2V | V2I-I2V | | Priority | |
| Traffic | V2V | | V2I-I2V | | V2I-I2V | | |
| Direction | | | | | | | |
| Minimum | 2 | 5 | 3 | 5 | 6 | 7 | 8 |
| PPPP | | | | | | | |
| Minimum | 50 ms | 100 ms | 100 ms | 100 ms | 100 ms | 100 ms | 100 ms |
| PDB | | | | | | | |
| Example | Critical | BSM | RSM, MAP, | SPAT, | TAM, TUM, | RWM | TCP, UDP |
| Messages | BSM, | | TIM, | RTCM | TUMack, | | |
| | BSM | | SSM/SRM | | SSM/SRM | | |
| | from | | for | | for priority | | |
| | Public | | preemption | | | | |
| | Safety | | | | | | |
| | Vehicle | | | | | | |

The minimum proximity services (ProSe) per-packet priority (PPPP) value indicates the priority assigned to a message, and a message with a lower PPPP value has a higher priority.

The minimum packet delay budget (PDB) indicates allowable delay for packet transmission.

As shown in Table 10, a critical BSM and a BSM from a public safety vehicle have the lowest PPPP value (i.e., the highest priority) and the smallest minimum PDB value. Accordingly, information on the school bus may be transmitted in such a BSM format.

In addition, an SDSM is not included among messages transmitted by a vehicle that transmits a BSM. That is, when the driver of the school bus transmits related information as a BSM, surrounding vehicles or RSUs may not transmit the information as an SDSM.

Accordingly, the present disclosure proposes transmitting information on a school bus not as an SDSM but as a BSM.

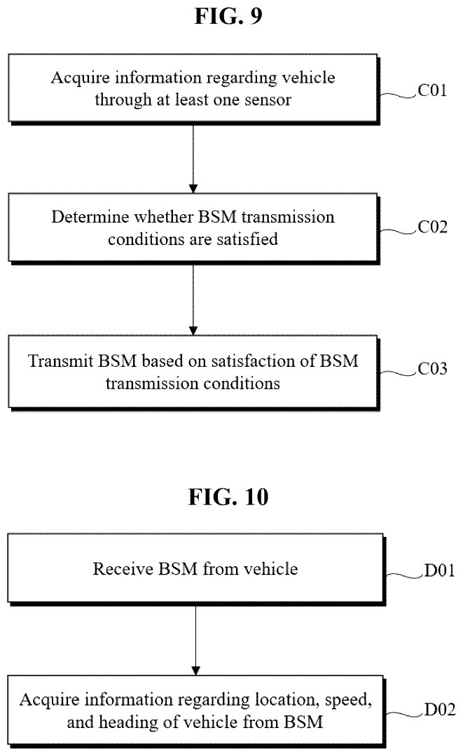

FIG. 9 illustrates a flow of a method in which a device transmits a BSM according to an embodiment.

Referring to FIG. 9, the device may acquire information regarding a vehicle through at least one sensor (C05).

The device may determine whether at least one of predefined BSM transmission conditions is satisfied, based on the acquired information regarding the vehicle (C10).

The device may transmit a BSM including information regarding a location, a speed, and a heading of the vehicle, based on that at least one of the BSM transmission conditions is satisfied (C15).

Based on that the vehicle is a school bus, the BSM transmission conditions may include: i) boarding of the school bus (loading), ii) unloading from the school bus, and iii) crossing in front of or behind the school bus. The BSM may include information regarding at least one of the conditions that is satisfied among the BSM transmission conditions.

Whether the BSM transmission conditions are satisfied may be determined based on information acquired through a sensor of the school bus or a sensor of an RSU.

Based on that at least two or more of the BSM transmission conditions are satisfied, the BSM may include information regarding each of the at least two or more satisfied conditions.

The BSM may be transmitted to at least one other vehicle around the school bus. Based on the transmission of the BSM, the at least one other vehicle may stop.

The PPPP of the BSM may be determined based on that the BSM is related to at least one of i) boarding of the school bus, ii) alighting from the school bus, and iii) crossing in front of or behind the school bus.

The BSM transmission conditions may further include a case where a passenger of the school bus drops an object.

The device may be a device provided in the school bus or an RSU around the school bus.

FIG. 10 illustrates a flow of a method in which a device receives a BSM according to an embodiment.

Referring to FIG. 10, the device receives a BSM from a vehicle (D05).

The device may acquire information regarding a location, a speed, and a heading of the vehicle from the BSM (D10).

The vehicle may be a school bus, and the BSM may include information regarding at least one of: i) loading to the school bus; ii) unloading from the school bus; or iii) crossing in front of or behind the school bus.

Based on that at least two or more of BSM transmission conditions are satisfied, the BSM may include information regarding each of the at least two or more satisfied conditions.

The device may be a vehicle around the school bus. The device may stop based on the reception of the BSM.

The device may be a device provided in the school bus or an RSU around the school bus.

Based on that at least two or more of the BSM transmission conditions are satisfied, the BSM may include information regarding each of the at least two or more satisfied conditions.

Various descriptions, functions, procedures, proposals, methods, and/or operation sequences of the present disclosure disclosed in this document may be applied to various fields requiring wireless communication/connections between devices (e.g., 5G), but the present disclosure is not limited thereto.

Hereinafter, examples will be described in more detail with reference to the drawings. In the following drawings and description, the same reference numerals may represent the same or corresponding hardware blocks, software blocks, or functional blocks, unless otherwise described.

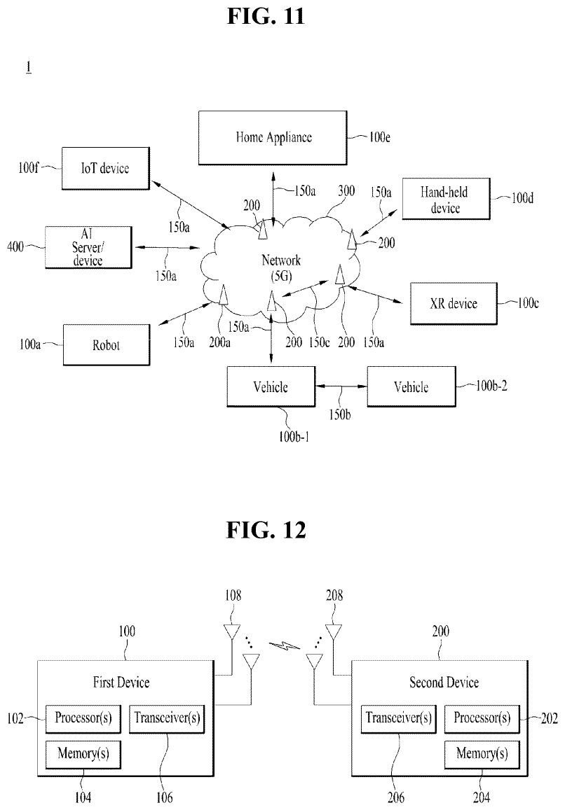

FIG. 11 illustrates a communication system applied to the present disclosure.

Referring to FIG. 11, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 12 illustrates a wireless device applicable to the present disclosure.

Referring to FIG. 12, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 11.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, a UE may include the processor(s) 102 connected to the RF transceiver and the memory(s) 104. The memory(s) 104 may include at least one program for performing operations related to the embodiments described above with reference to FIGS. 11 to 27.

Alternatively, a chipset including the processor(s) 102 and memory(s) 104 may be configured. The chipset may include: at least one processor; and at least one memory operably connected to the at least one processor and configured to, when executed, cause the at least one processor to perform operations.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

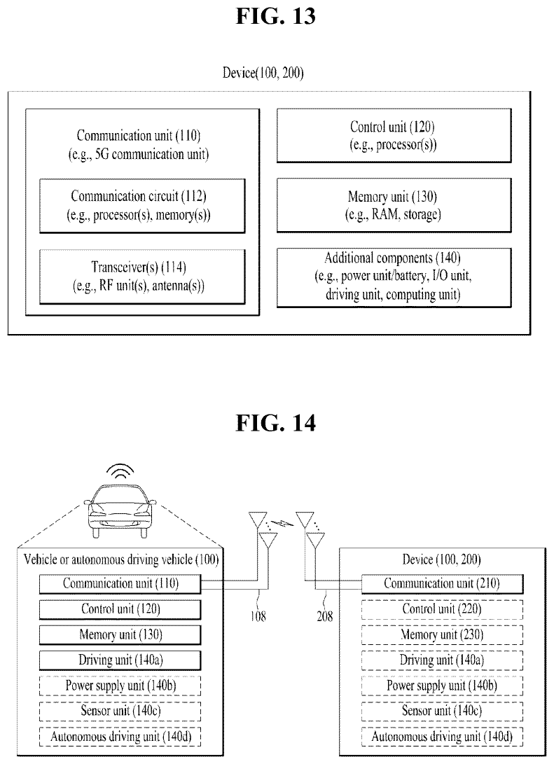

FIG. 13 illustrates another example of a wireless device applied to the present disclosure. The wireless device may be implemented in various forms according to a use-case/service (refer to FIG. 11)

Referring to FIG. 13, wireless devices 100 and 200 may correspond to the wireless devices 100 and 200 of FIG. 12 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 12. For example, the transceiver(s) 114 may include the one or more transceivers 106 and 206 and/or the one or more antennas 108 and 208 of FIG. 12. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 11), the vehicles (100b-1 and 100b-2 of FIG. 11), the XR device (100c of FIG. 11), the hand-held device (100d of FIG. 11), the home appliance (100e of FIG. 11), the IoT device (100f of FIG. 11), a digital broadcast terminal, a hologram device, a public safety device, an MTC device, a medicine device, a fintech device (or a finance device), a security device, a climate/environment device, the AI server/device (400 of FIG. 11), the BSs (200 of FIG. 11), a network node, etc. The wireless device may be used in a mobile or fixed place according to a use-example/service.

In FIG. 13, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 14 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 14, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 13, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology may generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various apparatuses in ITS.

1. A method performed by a device, the method comprising:
acquiring information regarding a vehicle through at least one sensor;
determining, based on the acquired information regarding the vehicle, whether at least one of predefined basic safety message (BSM) transmission conditions is satisfied; and
based on that the at least one of the BSM transmission conditions is satisfied, transmitting a BSM comprising information regarding a location, a speed, and a heading of the vehicle,
wherein based on that the vehicle is a school bus, the BSM transmission conditions comprises:
i) loading to the school bus;
ii) unloading from the school bus; and
iii) crossing in front of or behind the school bus, and
wherein the BSM comprises information regarding the at least one satisfied condition among the BSM transmission conditions.

2. The method of claim 1, wherein satisfaction of the BSM transmission conditions is determined based on information acquired through a sensor of the school bus or a sensor of a road side unit (RSU).

3. The method of claim 1, wherein based on that at least two or more of the BSM transmission conditions are satisfied, the BSM comprises information regarding each of the at least two or more satisfied conditions.

4. The method of claim 1, wherein the BSM is transmitted to at least one other vehicle around the school bus, and
wherein the at least one other vehicle stops based on the transmission of the BSM.

5. The method of claim 1, wherein based on that the BSM is related to at least one of: i) the loading to the school bus; ii) the unloading from the school bus; or iii) crossing in front of or behind the school bus, proximity services (ProSe) per-packet priority (PPPP) of the BSM is determined.

6. The method of claim 1, wherein the BSM transmission conditions further comprise a case where a passenger of the school bus drops an object.

7. The method of claim 1, wherein the device is a device provided in the school bus or a road side unit (RSU) around the school bus.

8. A non-transitory computer-readable recording medium having recorded thereon a program for executing the method of claim 1.

9. A method performed by a device, the method comprising:
receiving a basic safety message (BSM) from a vehicle; and
acquiring information regarding a location, a speed, and a heading of the vehicle from the BSM,
wherein the vehicle is a school bus, and
wherein the BSM comprises information regarding at least one of:
i) loading to the school bus;
ii) unloading from the school bus; or
iii) crossing in front of or behind the school bus.

10. The method of claim 9, wherein based on that at least two or more of BSM transmission conditions are satisfied, the BSM comprises information regarding each of the at least two or more satisfied conditions.

11. The method of claim 9, wherein the device is a vehicle around the school bus, and
wherein the device stops based on the reception of the BSM.

12. A device comprising:
a memory configured to store instructions; and
a processor configured to perform operations by executing the instructions,
wherein the operations performed by the processor comprise:
acquiring information regarding a vehicle through at least one sensor;
determining, based on the acquired information regarding the vehicle, whether at least one of predefined basic safety message (BSM) transmission conditions is satisfied; and
based on that the at least one of the BSM transmission conditions is satisfied, transmitting a BSM comprising information regarding a location, a speed, and a heading of the vehicle,
wherein based on that the vehicle is a school bus, the BSM transmission conditions comprises:
i) loading to the school bus;
ii) unloading from the school bus; and
iii) crossing in front of or behind the school bus, and
wherein the BSM comprises information regarding the at least one satisfied condition among the BSM transmission conditions.

13. The device of claim 12, wherein the device is a device provided in the school bus or a road side unit (RSU) around the school bus.

14-15. (canceled)
